(19) United States
(12) Patent Application Publication
(10) Pub. No.: US 2015/0112607 A1
(43) Pub. Date: Apr. 23, 2015

(54) SYSTEMS AND METHODS FOR RARE DISEASE PREDICTION AND TREATMENT

(71) Applicant: Bioneur LLC, Carlsbad, CA (US)

(72) Inventor: Hendrik Anton Meijer, Carlsbad, CA (US)

(21) Appl. No.: 14/563,910

(22) Filed: Dec. 8, 2014

Related U.S. Application Data
(63) Continuation-in-part of application No. 14/011,487, filed on Aug. 27, 2013, now abandoned.

(51) Int. Cl. G06F 19/00

(52) U.S. Cl. CPC G06F 19/345
USPC 702/19; 514/789

(57) ABSTRACT

A rare disease matching and prediction portal is provided where a number of symptoms are matched with a list of rare diseases to produce candidate diseases, after which the candidate diseases are evaluated based on weighted lists of symptoms for each candidate disease to produce a confidence indicating a likelihood that a patient suffers from one of the rare diseases. Information curated from publications and other curated databases related to rare diseases are utilized to determine the weighted list of symptoms for each disease based on prevalence relevance of each symptom to each candidate disease, and a customized algorithm is applied to determine the confidences for the candidate diseases. Along with the confidences, the portal may provide a disease profile for each disease which includes possible treatments for the candidate diseases. The patient may then be treated for at least one of the candidate diseases based on the confidences.

### BACKGROUND

1. Field of the Invention

Various embodiments described herein relate generally to the field of health-related predictive analytics, and more particularly to correlating multiple symptoms with rare disease information and applying customized algorithms to generate confidence values for possible rare disease matches.

2. Related Art

Globally, approximately 7000 rare diseases have been identified. Rare diseases are notoriously difficult to diagnose and most of them go unnoticed and/or receive little attention because they affect only thousands or sometimes even smaller numbers of patients worldwide. Collectively there are about 350 million people living around the world with a rare disease.

Rare diseases are often chronic, debilitating, life-threatening and with degenerative progression. They not only have an impact on the patients, but they also have an impact on their family, friends, their physicians and society. 80% of rare diseases are genetic in origin and thus are present throughout a person's life. 50% of the people affected by rare diseases are children. 30% of children with a rare disease will not live to see their 5th birthday. A recent survey showed that it takes 7.6 years in the US and 5.6 years in the UK for a patient with a rare disease to be properly diagnosed.

One can only speculate about the time it takes to diagnose patients with a rare disease in countries outside of the US and Europe. Today, medical schools around the world still do not pay sufficient attention to rare diseases, resulting in a lack of awareness within the medical communities.

Although great progress has been made with the development of treatments for rare diseases over the past three decades, for the vast majority of these diseases there is still no approved treatment yet.

The good news is that for about 480 of the 7000 rare diseases that have been identified worldwide an FDA and/or EMA approved treatment is developed and marketed. However, as long as one cannot make or get a proper diagnosis first that knowledge is irrelevant.

Leading and emerging biopharmaceutical companies have developed and market orphan drugs for about 480 rare diseases. All these diseases will be included in this portal. Thanks to these companies thousands of patients (mostly in Western countries) benefit from these, sometimes life changing treatments on a daily basis. The impact that some of these treatments have on patients and their families, is extraordinary. Tens of thousands of patients are still waiting to be diagnosed.

Because rare diseases are inherently difficult to diagnose, not in the least because of the significant lack of knowledge about these diseases within the medical community, physicians increasingly use search engines. However, search engines are not designed for rare diseases. This is because search engines consider pages important when they are linked to by other pages. Rare diseases by definition are unlikely to have a high profile on the web relative to more common diseases. So the difficulty of diagnosing a rare disease remains unchanged.

### SUMMARY

Systems and methods are provided herein for a rare disease matching and prediction portal where physicians can select from a list of patient symptoms which are then matched with a list of rare diseases to produce candidate diseases, after which the candidate diseases are evaluated based on weighted lists of symptoms for each candidate disease to produce a confidence indicating a likelihood that a patient suffers from one of the rare disease. Information curated from peer reviewed medical and scientific publications related to rare diseases are utilized to determine the weighted list of symptoms for each disease, and a customized algorithm is applied to determine the confidences from a list of candidate diseases. Along with the confidences, the portal may provide a disease profile for each disease which includes additional tests, specialized facilities and experts, and possible treatments for the candidate diseases. Additional disease specific testing may be conducted to confirm a diagnosis. The patient may then be treated for at least one of the candidate diseases based on the confidences.

In a first exemplary aspect, a method of rare disease prediction comprises the steps of: receiving one or more patient symptoms pertaining to a patient; comparing the one or more patient symptoms with known symptoms of diseases to identify one or more candidate diseases; applying a predetermined weighted value to each of the one or more patient symptoms for each candidate disease, wherein the weighted value is determined based on a relevance of each symptom to each candidate disease; generating a confidence for each candidate disease based on the one or more patient symptoms and applied weighted values; identifying at least one treatment for each candidate disease; and treating the patient with the at least one treatment.

In a further aspect, a system for rare disease prediction comprises a receiving unit which receives one or more patient symptoms pertaining to a patient; a disease matching unit which compares the one or more patient symptoms with known symptoms of diseases to identify one or more candidate diseases; a symptom weighting unit which applies a predetermined weighted value to each of the one or more patient symptoms for each candidate disease, wherein the weighted value is determined based on a relevance of each symptom to each candidate disease; a confidence generating unit which generates a confidence for each candidate disease based on the one or more patient symptoms and applied weighted values; and a treatment recommendation unit which identifies at least one treatment for one or more of the candidate diseases.

Other features and advantages should become apparent from the following description of the preferred embodiments, taken in conjunction with the accompanying drawings.

### BRIEF DESCRIPTION OF THE DRAWINGS

Various embodiments disclosed herein are described in detail with reference to the following figures. The drawings are provided for purposes of illustration only and merely depict typical or exemplary embodiments. These drawings are provided to facilitate the reader's understanding and shall not be considered limiting of the breadth, scope, or applicability of the embodiments. It should be noted that for clarity and ease of illustration these drawings are not necessarily made to scale.

FIG. 1 is a block diagram illustrating an exemplary system for predicting likelihoods of rare diseases in patients, according to one embodiment.

FIG. 2 is a block diagram illustrating an exemplary prediction server configured to predict the likelihoods of rare diseases in patients, according to one embodiment.

FIG. 3 is a flow diagram illustrating an exemplary method of predicting the likelihoods of rare diseases in patients, according to one embodiment.

FIG. 4 is a flow diagram illustrating an exemplary method of predicting the likelihoods of rare diseases in patients and treating the patients for at least one rare disease, according to one embodiment.

FIG. 5 is a block diagram that illustrates an embodiment of a computer/server system upon which an embodiment of the inventive methodology may be implemented.

The various embodiments mentioned above are described in further detail with reference to the aforementioned figures and the following detailed description of exemplary embodiments.

### DETAILED DESCRIPTION

The systems and methods described herein provide a portal for predictive analytics relating to comprehensive lists of symptoms weighted for each disease in order to determine the likelihood that a patient may suffer from a rare disease. The embodiments described herein enable physicians to query multiple symptoms that the patient presents with and receive a list of candidate diseases and confidences associated with each candidate disease. The symptoms of these rare diseases are ranked and/or weighted according to its specificity with a rare disease. The portal will process the selected symptoms and their disease-specific weights with a customized algorithm to generate a confidence for each candidate disease. The confidences are then displayed to the physician along with disease profile information including confirmatory diagnostic tests, specialized facilities and possible treatments.

The embodiments do not provide a diagnostic indication, but can be regarded a “hypothetico-deductive method” in the sense that the suggested candidate diseases can be viewed as hypotheses that require further disease-specific testing to confirm a positive or negative diagnosis.

The beneficiaries of these systems include patients, physicians, policy makers and industry. First and foremost, thousands of currently undiagnosed and/or misdiagnosed patients suffering from a rare, chronic, debilitating, life-threatening but treatable disease, around the world. Physicians are provided with a tool that supports them in the process of diagnosing a patient with a rare treatable disease, faster than their current capability. Biopharmaceutical companies that developed and market these orphan drugs will have the opportunity to serve many more patients around the world and meet their unmet medical needs faster and without having to make significant investments in local country specific infrastructure and the like. As a result, its revenue will grow faster. Policy makers benefit as they look for statistics around the number of patients with a disease in a region or world-wide.

The embodiments described herein will increase the number of and expedite access to subjects eligible to participate in clinical trials. The objectives are to 1) increase the number of and access to naïve (previously untreated) patients, 2) reduce the time of accruing these patients, 3) reduce the overall time of all phases of clinical trials, 4) reduce the overall costs of clinical trials, 5) reduce the overall “time to market” for a candidate drug and treatment of patients suffering from a rare disease, and 6) generate ROI faster. The method can be extended and adapted to rare diseases for which no treatment with an orphan drug is available but for which clinical trials are on-going or scheduled to be conducted. A patient predicted to have an identified rare disease might meet the inclusion criteria for these clinical trials. Finding patients suffering a specific rare disease and that can participate in a clinical trial is a significant challenge for CROs (Clinical Research Organizations). A similar portal may be developed to be used by the general public for rare disease prediction that uses lay medical terms and descriptions. Furthermore, the portal can be developed for common diseases without modification using the same principles for rare disease prediction, only with a larger data set of symptoms, diseases and weights.

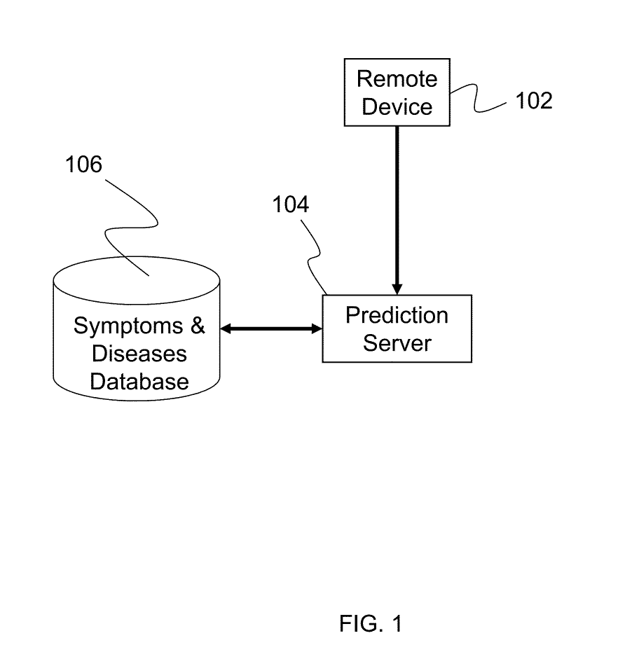

FIG. 1 illustrates a block diagram of one embodiment of a system for predicting rare diseases. A physician or health care provider will access the system from a remote device 102 at the physician's location, allowing the physician to take advantage of the system from anywhere. The remote device 102 is connected with a prediction server 104, which is configured to receive a user selection of symptoms from a list of symptoms. In one embodiment, the doctor doesn't provide his or her own list of symptoms, but just clicks on the appropriate symptoms his/her patient presents with from a predetermined list of symptoms. In one embodiment, the list of patient symptoms may also include a preset weight (level of relevance) of each symptom to each disease. The higher the number of relevant symptoms for each disease, the higher a specificity is for those combined symptoms.

In one embodiment, a prediction database 106 connected with the prediction server 104 may be configured to store different types of information needed to process the selected patient symptoms and match the patient symptoms with one or more of the rare disease stored in the portal. The portal applies preset weights to each symptom of each rare disease to identify a list of candidate diseases, identifies disease profile information for the candidate diseases, and suggest treatments. The system is designed to avoid transmitting or storing any information identifying the patient in order to avoid any risks of violating patient privacy rights. Therefore, the user only selects symptoms from a list and follows the steps to obtain predicted outcomes without creating a patient profile or entering any personally identifiable information about the patient. Although only one database is illustrated herein, the system could alternatively contain a plurality of databases to store various categories of information instead of a single database divided into normalized database tables.

In this embodiment, a prediction database 106 is provided which stores lists of diseases and symptoms and their associations with each other. The symptoms may be associated with the diseases through various tables, such as a table of diseases with a list of symptoms known to exist for each disease. Another separate database or database table may contain synonyms for symptoms and diseases in order to more accurately match the selected symptoms and diseases. The prediction database 106 may store a list of preset weights that are applied to each symptom for each particular disease, although some symptoms may not have a weight. If a symptom lacks a weight, the applied weight value may be zero. The weights reflect the relevance of a particular symptom to a particular disease. The relevance may be determined by a number of different methods and based on a plurality of different information. For example, a symptom which is the primary symptom in a rare disease and which is also exclusive only to that rare disease may receive a weight value of 1 from a scale of 0 to 1, since the existence of that symptom is a definitive indication that the patient suffers from the associated rare disease.

The prediction database 106 may also be utilized to store complete descriptions and other information about each rare disease, such as detailed descriptions of the symptoms, how they are presented, the progression of the disease, diagnostic tests that can confirm its existence and specialists and facilities equipped to handle the disease. The prediction database 106 may store a list of treatments that are applicable to certain rare diseases, such as lists of orphan drugs. The prediction database 106 may also include information on the availability and approval of certain treatments in certain locations, the name and location of laboratories which can perform needed tests, the availability of clinical trials relating to the disease and information on the efficacy of the treatments, costs, etc. The system may therefore provide clinical trials with access to additional naïve patients that would otherwise remain unidentified and undiagnosed.

In one example, information on new symptoms of certain rare diseases may be incorporated into the prediction database 106, while information on the relevance of a particular symptom to a particular rare disease may be incorporated into the prediction database 106 to adjust the weight of that particular symptom with respect to that particular rare disease. All of the information can be added to the prediction database 106 to improve the information available on each disease, and updates on new treatments or the results of new treatments may be added to the database 106.

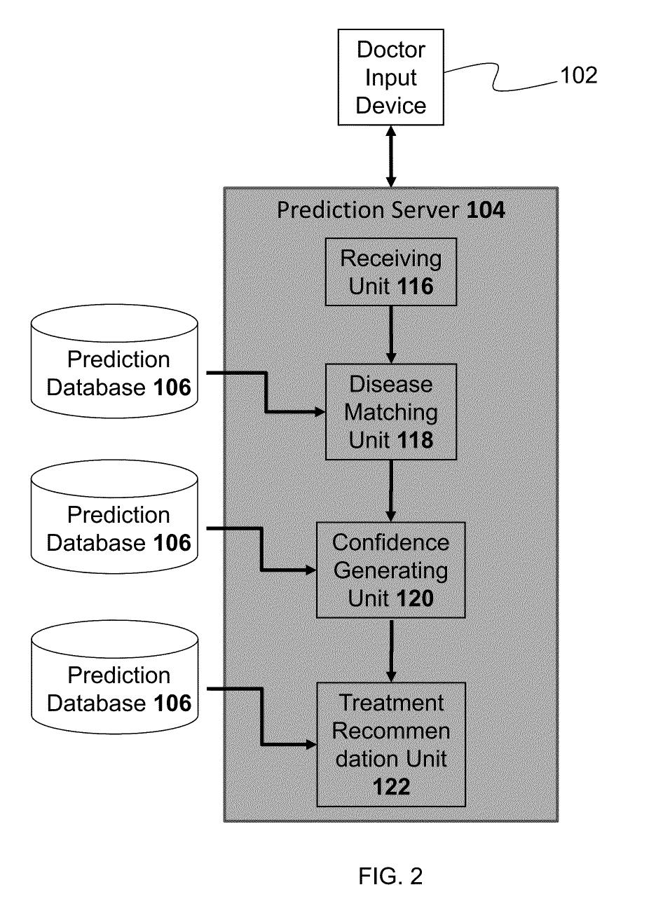

The prediction server may be configured with one or more processing elements to receive, analyze and display information relating to the symptoms and confidences for rare diseases. FIG. 2 illustrates a block diagram of the prediction server 104 with a receiving unit 116 configured to receive the list of selected patient symptoms from the input device 102. The received list of selected patient symptoms is then forwarded to a disease matching unit 118 which matches the list of selected patient symptoms with the symptoms and diseases in the prediction database 106 in order to produce a list of candidate diseases, as will be described further below. The list of candidate diseases is then forward to a confidence generating unit 120 which accesses the prediction database 108 to utilize the weights assigned to each symptom for each disease in order to determine a confidence for each candidate disease. Once the confidences are computed, the prediction server 104 may store the results in an attached database or forward the results back to the input device 102 for viewing by the physician. In another embodiment, the confidences are then forwarded to a treatment recommendation unit 122 which accesses the prediction database 106 to determine one or more treatments for the candidate diseases. The various types of treatments are described in further detail below. The treatments may also be forwarded back to the input device 102 for viewing by the physician, who can then prescribe a particular treatment, such as medication, surgery, genetic modification, or even a referral to a specialist in the field of the rare diseases or a medical facility or clinical trial which specializes in the rare disease.

### Methodology for Predicting Disease

The portal will provide for a consistent, accurate real-time prediction of the supported rare diseases by utilizing a symptoms weighting database of predetermined weights for each symptom of each disease. The diagnosis will rely on a curated relational database of symptoms and diseases. Rare diseases are then diagnosed by a unique combination of a set of weighted symptoms and varying levels of specificity.

Determining a relevance of each symptom to each candidate disease improves the confidence of the prediction. It is possible that multiple diseases are diagnosed by a given set of symptoms, and it is also plausible that a given disease is diagnosed by multiple sets of symptoms. Hence, the relationship between symptoms and diseases is that of many-to-many. In one embodiment, a set could contain one or more symptoms with varying levels of relevance, which could also be incorporated into the method of predicting disease. Some symptoms may need to be described in terms of the relevance of the symptom to a disease. The higher the relevance of a combination of specific symptoms for a disease, the higher the overall specificity, or confidence, of that disease. For example, the individual symptoms might not be specific to one rare disease, but the combination of all of them might. Each symptom within a set may therefore contribute disproportionately to the prediction of a disease. In one embodiment, the relevance of a particular symptom may be utilized as a pre-weighting factor for a symptom.

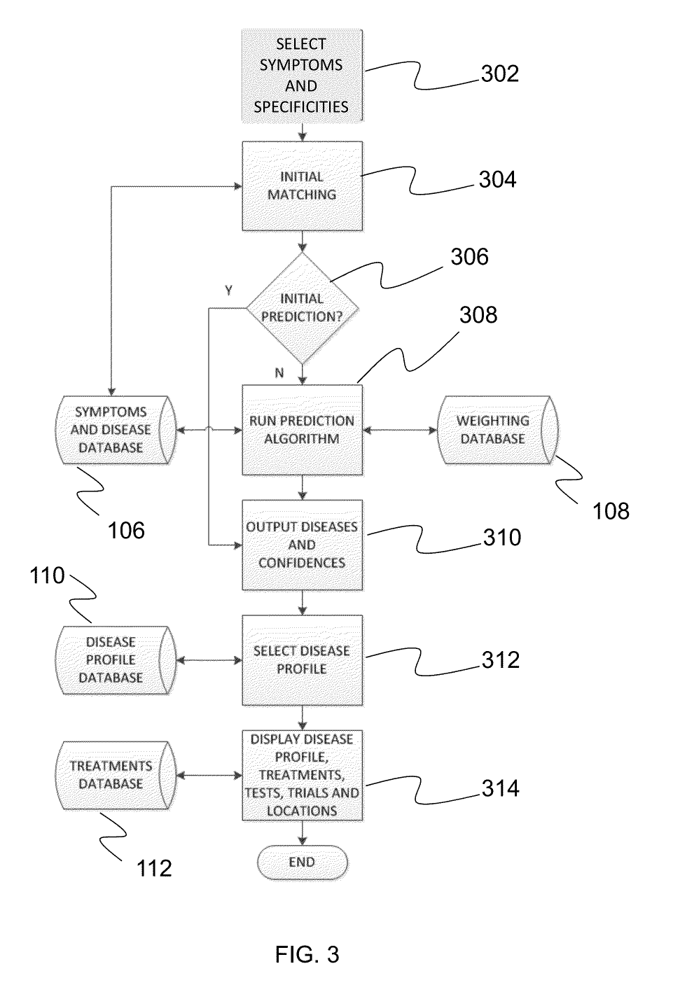

FIG. 3 illustrates one embodiment of a method for predicting the likelihood of rare diseases. In step 302, the physician or user first selects a set of patient symptoms at the portal, which is then received at the prediction server. The physician may be interacting with the portal via a web-interface or through an application running on the physician's input device, such as a desktop or portable computing device. In step 304, an initial matching process is performed by matching the list of selected patient symptoms with the list of symptoms stored in the associated diseases and symptoms database. Any disease with symptoms that match the list of patient symptoms is selected and then identified as a candidate disease. At decision step 306, if the list of patient symptoms is an exact match with a list of symptoms for only one disease (“Y” at step 306), the remaining process may skip the prediction algorithm (described below in step 308) and the identified disease may be immediately output as the predicted disease at step 310. The confidence value would effectively be 100%, as there would be no other candidate diseases with the same set of symptoms. If the list of candidate diseases does not produce an exact match (“N” at step 306), the process continues to the prediction algorithm in step 308.

In step 308, the candidate diseases identified based on the initial matching are input into a prediction algorithm. The prediction algorithm is applied to each candidate disease using the selected symptoms that are each weighted for each candidate disease (using preset weighted values obtained from the prediction database 106) to determine a confidence for each candidate disease that indicates a likelihood that the patient suffers from that particular disease. In one embodiment, the confidence represents a specificity, or sum of the individual weights of each symptom for each disease, where the more relevant symptoms present, the higher the specificity. In one embodiment, the predictive algorithm sums the total weights for all of the identified symptoms, raises them by a value corresponding to the number of symptoms of the candidate disease not identified in the list of patient symptoms, and then subtracts them by a constant. The predictive algorithm may therefore be understood by the following equation:

$${C}_{d} = [ {( {\sum }_{i = 1}^{N} {w}_{i} )}^{D + 1} - 0.01 ] * 100 \% \qquad ( 1 )$$

Where C_{d} is the confidence value, wᵢ is the weight w for a symptom, i, N is the number of identified patient symptoms, and D is the number of symptoms not identified from a list of all symptoms for a candidate disease.

In one embodiment, the weights for each symptom of each disease are determined based on a relevance of a symptom to a particular disease. The relevance may be determined from a plurality of different knowledge sources and given a value based on a proprietary methodology indicative of the relevance of the symptom for a specific disease. This may include empirical observations and knowledge of a symptom's relationship with a particular disease. In an alternative embodiment, the weights for each symptom may be determined by a weighting algorithm which uses a plurality of factors to determine the weighted value. Details of the weighting algorithm will be provided further below.

In step 310, the predicted diseases and confidences are output to the physician. The confidences may be output in order of the most likely disease to the least likely disease, and the number of candidate diseases displayed may be truncated to only provide the top five predictions or only the predictions over a certain threshold confidence value. The confidences are represented herein as numerical values indicating a percentage from 0-100 for ease of understanding. However, the confidence may be represented as another numerical value on a different scale, or even converted to a descriptive term indicating whether it is “likely,” “very likely” or “unlikely” that the patient is suffering from the candidate disease.

Once the confidences and candidate diseases are output to the physician, in step 312, the portal may display a user interface with a disease profile for each candidate disease, as has been described above. The disease profile may provide detailed explanations of the disease, symptoms, timeline of onset and progression, etc. that is stored in the prediction database 106. The user interface may then display, in step 314, the disease profile information, including possible tests that a physician may prescribe to make a definitive diagnosis of the rare disease, possible treatments for the disease (such as a list of orphan drugs that are not typically known to the medical community), clinical trials available for potential new treatments and treatment centers or specialized medical centers that specialize in the diagnosis and treatment of a rare disease. In one embodiment a disease profile may be sponsored by one of the treatment providers, clinical trial sponsors, treatment locations or diagnostic test providers.

### Weighting Algorithm

In one embodiment, a weighting algorithm may be used to determine a weight for each symptom of each disease. In this embodiment, the weighting algorithm is a function of five factors:
1. Mandatory Symptoms: The number mandatory symptoms in a set. In the absence of evidence to the contrary (in literature or curated databases), all mandatory symptoms will receive equal weightage by default.
2. Optional Symptoms: The number of optional symptoms. Presence of optional symptoms in addition to the presence of all mandatory symptoms will enhance the confidence assigned to overall predicted diagnosis.
3. Relevance of Symptoms: The relevance of a symptom pertains to its relationship to a particular disease. When a very common symptom like anemia occurs with a rare disease, we would certainly give this symptom a very low weight because of its low level of relevance to this specific disease. In contrast, an uncommon symptom like anhydrosis (inability to sweat) is very disease specific and highly relevant to a specific disease, and will therefore be weighted higher.
4. Combination of Symptoms: Combination (subset) of symptoms collectively associated with the disease.
5. Likelihood Ratio: Likelihood ratio represents the number of times a symptom was observed in cases divided by the total number of cases of a disease. For example, a certain symptom may or may not always be associated with a specific disease. This could be represented in terms of a ratio of the number of disease cases reporting this symptom (for e.g., in a database) to the total number of known cases with this disease. Since the numerator would be less than or equal to the denominator, the range of valid values for the likelihood ratio would be between 0.0 and 1.0.

In one embodiment, the weight for a particular symptom may be calculated by the following equation:

$${w}_{i} = \frac{1}{N} * {K}^{D} * {L}_{i} \qquad ( 2 )$$

where wᵢ is the weight, N is the total number of identified patient symptoms, K^{D} is a constant between 0.1 to 0.9, and Lᵢ is a likelihood ratio representing the number of times a symptom i was observed in cases divided by the total number of cases of a disease. As previously described, a unique weighted value is assigned to each symptom of each disease, such that the same symptom may have different weights for different diseases since that symptom's importance to each disease may vary.

### Scoring and Selection Algorithm

In an alternative embodiment, a scoring and selection algorithm is used to identify candidate diseases, generate a score for the candidate diseases and determine whether the candidate diseases exceed a threshold. The score for a disease is a function of the disease in question and a set of symptoms: Score(D,{S}), where D=Disease and {S}=A set of symptoms. The score for a disease is the weighted count of the intersection between the mandatory symptoms for the disease and the provided symptoms, plus the weighted count of the intersection between the optional symptoms for the disease and the provided symptoms. Thus, the equation for determining the score of a diseases is as follows in Equation 3:

Score(D,{S})=(Count({Sₘ(D)}∩{S})*Wₘ)+(Count({Sₒ(D)}∩{S})*Wₒ) (3),

where:

{S}=A set of symptoms, {Sₘ(D)}=Set of all mandatory symptoms for disease D,

{Sₒ(D)}=Set of all optional symptoms for disease D,

Wₘ=Weighting factor for mandatory symptoms,

Wₒ=Weighting factor for optional symptoms,

In the current implementation, Wₘ=5 and Wₒ=1.

The visibility of a disease in the result set is a Boolean operation based on whether the score for the disease is greater than a pre-computed threshold value. In one embodiment, the visibility is determined by Equation 4:

Visibility(D,{S})=If(Score(D,{S})≧Threshold)then true else false (4).

The visibility threshold (Threshold) is determined by a bi-state function which evaluates to a pre-set value, T, if any disease's score is greater than or equal to T for the set of all possible diseases, or evaluates to 0 if not. As such, the Threshold may be determined, in one embodiment, by Equation 5:

Threshold=If(Max(Score({D},{S}))<T)then 0 else T (5),

where:

{D}=Set of all diseases,

T=Threshold score for disease inclusion, and

Count=The number of items in a set.

In the current implementation, T=20.

The above diseases scoring and selection algorithm provides an additional step-wise process to determine candidate diseases.

### Data Standards and Regulatory Compliance Requirements

Because the medical terminologies vary significantly within the practice (both within a country/region as well as globally), it is important to adhere to controlled vocabularies and data standards to enable consistent usage of naming conventions. A single symptom or disease may have multiple names. The following medical and clinical data standards will be adopted as appropriate:

MESH (Medical Subject Headings): www.nlm.nih.gov/mesh/

Disease Ontology: disease-ontology.org/

ICD: www.who.int/classifications/icd/en/

SNOMED: www.ihtsdo.org/snomed-ct/

OMIM: Online Mendelian Inheritance in Man (www.omim.org/)

Web-based software quality requirements that will be adhered to will include: 1) the portal will be developed using a strict Agile software development methodology at capability maturity model (CMM) Level 3 maturity; 2) 508 compliance: www.section508.gov/; and 3) W3C Web Accessibility Initiative to promote a high degree of usability for people with disabilities. The portal will comply with all applicable and evolving regulatory requirements set-forth by FDA, EMA and other international and national agencies.

### Disease Profile Information

In one embodiment, the system includes a scroll down menu with a disease prediction list. Clicking on the name of a rare disease a multi-page overview appears with detailed information about the disease, symptoms, diagnosis and treatment(s). The system will include names of local, regional and international laboratories that do have testing experience for rare diseases; patient societies, advocacy groups and rare disease non-profit organization; rare disease experts and rare disease centers of excellence and much more.

Taking into account that not all countries have the necessary resources to perform the relevant tests, names of local, regional and international laboratories that do have testing experience for rare diseases will be included. This portal will include the names of national and international clinical rare disease experts and their centers of excellence. This portal will include information about local, regional and international patient societies and advocacy groups.

### Treatments

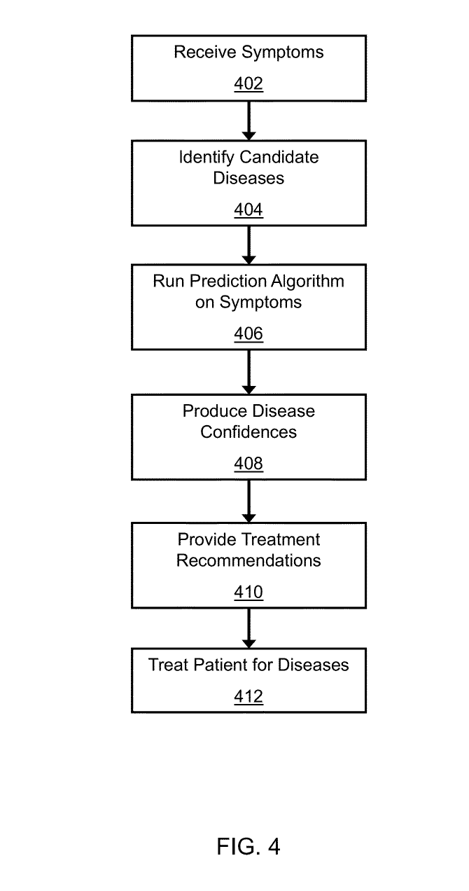

In one embodiment, information about one or more treatments is included. Its up to the physicians to conduct further testing to confirm a diagnosis and determine how to treat his/her patient. In one embodiment, the method described herein includes treating the patient for one or more of the diseases based on the confidence values provided by the aforementioned method. FIG. 4 illustrates one embodiment of a method of predicting a rare disease and treating a patient for the rare disease, wherein the steps are similar to those described above, including: receiving a list of symptoms in step 402; matching the received symptoms with possible diseases to produce a list of candidate diseases in step 404; running the prediction algorithm in step 406 to apply the customized weights for each symptom of each disease to the candidate diseases, which produces disease confidences in step 408; and providing treatment recommendations in step 410 such as possible treatments, tests, clinical trials, locations and experts. Based on the treatment recommendations, the patient is then treated for one or more of the candidate diseases in step 412, for example by administering a treatment such as an orphan drug, performing a test to confirm a diagnosis of the disease, enrolling the patient in a clinical trial for the disease, or forwarding the patient to an expert in the disease or a medical facility which specializes in the disease.

### Patient Interface

The system may also provide an interface and content for patients and related parties separate from the physician interface. To increase the awareness about rare diseases in the general public, a similar portal would be available for use by patients and their families. This portal will describe the same 400 or more rare diseases, symptoms and treatment(s) but in lay terms only. Everything, including the query of multiple symptoms will be lay term based. This portal would be available in all major languages. With the knowledge obtained patient(s) can visit their physician and have him/her use the portal for further research.

The patient interface may also provide for interactions between patients suffering from similar rare disease conditions so they can discuss the treatments, symptoms and overall experiences.

### Disease and Symptom Analytics

In one embodiment, the information received from the physicians regarding the symptoms may be utilized along with the predicted confidences as additional analytics helpful to further improve the accuracy of identifying rare diseases and their symptoms. As the system does not collect information that would identify a specific individual patient in order to protect privacy, the information collected would be limited to a selection of symptoms, specificities and predicted diseases associated with an anonymous patient. However, information on the location of the physician inputting the patient data could be used in order to track the locations of cases of rare disease. As previously described, the system may also be configured to continuously receive third party information from publications, papers, hospitals or other healthcare facilities, etc. that collect patient data.

### Computer-Implemented Embodiment

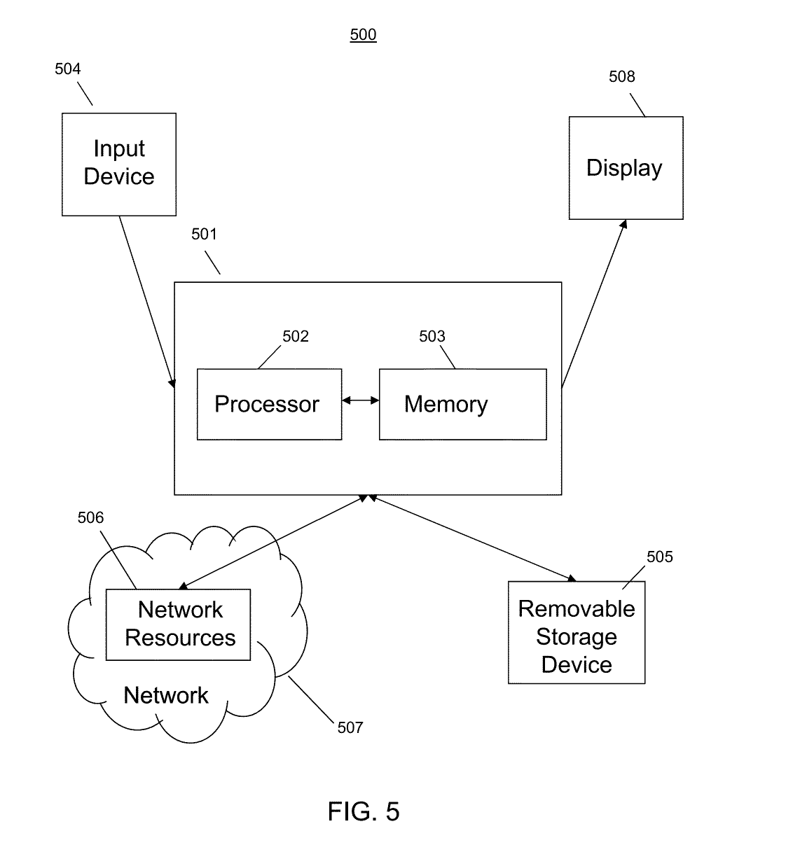

FIG. 5 is a block diagram that illustrates an embodiment of a computer/server system 500 upon which an embodiment of the inventive methodology may be implemented. The system 500 includes a computer/server platform 501 including a processor 502 and memory 503 which operate to execute instructions, as known to one of skill in the art. The term “computer-readable storage medium” as used herein refers to any tangible medium, such as a disk or semiconductor memory, that participates in providing instructions to processor 502 for execution. Additionally, the computer platform 501 receives input from a plurality of input devices 504, such as a keyboard, mouse, touch device or verbal command. The computer platform 501 may additionally be connected to a removable storage device 505, such as a portable hard drive, optical media (CD or DVD), disk media or any other tangible medium from which a computer can read executable code, data or write results to. The computer platform may further be connected to network resources 506 which connect to the Internet or other components of a local public or private network. The network resources 506 may provide instructions and data to the computer platform from a remote location on a network 507. The connections to the network resources 506 may be via wireless protocols, such as the 802.11 standards, Bluetooth® or cellular protocols, or via physical transmission media, such as cables or fiber optics. The network resources may include storage devices for storing data and executable instructions at a location separate from the computer platform 501. The computer interacts with a display 508 to output data and other information to a user, as well as to request additional instructions and input from the user. The display 508 may therefore further act as an input device 504 for interacting with a user.

While various embodiments have been described above, it should be understood that they have been presented by way of example only, and not of limitation. The breadth and scope should not be limited by any of the above-described exemplary embodiments. Where this document refers to technologies that would be apparent or known to one of ordinary skill in the art, such technologies encompass those apparent or known to the skilled artisan now or at any time in the future. In addition, the described embodiments are not restricted to the illustrated example architectures or configurations, but the desired features can be implemented using a variety of alternative architectures and configurations. As will become apparent to one of ordinary skill in the art after reading this document, the illustrated embodiments and their various alternatives can be implemented without confinement to the illustrated example. One of ordinary skill in the art would also understand how alternative functional, logical or physical partitioning and configurations could be utilized to implement the desired features of the described embodiments.

Furthermore, although items, elements or components may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method of disease prediction, comprising the steps of:
receiving one or more patient symptoms pertaining to a patient;
comparing the one or more patient symptoms with known symptoms of diseases to identify one or more candidate diseases;
applying a predetermined weighted value to each of the one or more patient symptoms for each candidate disease, wherein the weighted value is determined based on a relevance of each symptom to each candidate disease;
generating a confidence for each candidate disease based on the one or more patient symptoms and applied weighted values;
identifying at least one treatment for each candidate disease; and
treating the patient with the at least one treatment.

2. The method of claim 1, wherein the confidence is generated by summing the individual weights of each symptom to determine a specificity of the symptoms for each candidate disease.

3. The method of claim 1, further comprising identifying the one or more candidate diseases by identifying a disease with at least one known symptom which matches at least one of the one or more patient symptoms.

4. The method of claim 1, further comprising displaying each candidate disease above a threshold confidence to a user.

5. The method of claim 4, further comprising identifying at least one treatment for at least one candidate disease above the threshold confidence.

6. The method of claim 1, wherein the patient is treated for the candidate disease with the highest confidence value.

7. The method of claim 1, wherein the at least one treatment is an orphan drug.

8. The method of claim 1, further comprising performing at least one diagnostic test on the patient based on the confidence for each candidate disease to diagnose the at least one candidate disease.

9. The method of claim 1, wherein the at least one treatment is one or more of: a clinical trial related to at least one candidate disease; a medical facility specializing in the treatment of the at least one candidate disease; and a medical expert specializing in the treatment of the at least one candidate disease.

10. A system for disease prediction, comprising:
a receiving unit which receives one or more patient symptoms pertaining to a patient;
a disease matching unit which compares the one or more patient symptoms with known symptoms of diseases to identify one or more candidate diseases;
a symptom weighting unit which applies a predetermined weighted value to each of the one or more patient symptoms for each candidate disease, wherein the weighted value is determined based on a relevance of each symptom to each candidate disease;
a confidence generating unit which generates a confidence for each candidate disease based on the one or more patient symptoms and applied weighted values; and
a treatment recommendation unit which identifies at least one treatment for one or more of the candidate diseases.

11. The system of claim 10, wherein the confidence is generated by summing the individual weights of each symptom to determine a specificity of the symptoms for each candidate disease.

12. The system of claim 10, wherein the disease matching unit identifies the one or more candidate diseases by identifying a disease with at least one known symptom which matches at least one of the one or more patient.

13. The system of claim 10, further comprising a display unit which displays each candidate disease above a threshold confidence to a user.

14. The system of claim 10, wherein the at least one treatment is for the candidate disease with the highest confidence value.

15. The system of claim 10, wherein the at least one treatment is an orphan drug.

16. The system of claim 10, wherein the treatment recommendation unit performs at least one diagnostic test on the patient based on the confidence for each candidate disease to diagnose at least one candidate disease.

17. The system of claim 10, wherein the at least one treatment is one or more of: a clinical trial related to at least one candidate disease; a medical facility specializing in the treatment of the at least one candidate disease; and a medical expert specializing in the treatment of the at least one candidate disease.
